(19) United States
(12) Patent Application Publication
(10) Pub. No.: US 2019/0347617 A1
(43) Pub. Date: Nov. 14, 2019

(54) PRINTING AND PROJECT COLLABORATION SYSTEM AND METHOD

(71) Applicant: James J. Moore, San Marcos, CA (US)

(72) Inventor: James J. Moore, San Marcos, CA (US)

(21) Appl. No.: 16/385,220

(22) Filed: Apr. 16, 2019

Related U.S. Application Data
(60) Provisional application No. 62/632,142, filed on Feb. 19, 2018.

(51) Int. Cl. G06Q 10/10; G06F 3/12; G06F 16/176

(52) U.S. Cl. CPC G06Q 10/101; G06F 3/1203; G06F 16/1774; G06F 3/1238; G06F 3/1272

(57) ABSTRACT

A computerized method and system for printing and project collaboration over a network, including generating a virtual collaborative plan room within a project management system associated with a job and a plurality of user accounts able to login concurrently; associating uploaded project files with the job; publishing a subset of the project files to a plurality of contractor user accounts along with a request for a bid and managing bids; locking a file for editing particular user accounts; processing edit requests to the locked file in real-time thereby; automatically recording edits to project files; unlocking the locked file thereby updating the project files; sending a print request to a printing system, including: a copy of one or more project files, a printing parameter, and a printing price request; receiving a printing price from the printing system; and publishing the printing price.

### CROSS-REFERENCE TO RELATED APPLICATIONS

This invention claims priority, under 35 U.S.C. § 120, to the U.S. Provisional Patent Application No. 62/632,142 to Moore et al. filed on Feb. 19, 2018, which is incorporated by reference herein in its entirety.

### BACKGROUND OF THE INVENTION

### Field of the Invention

The present invention relates to systems and methods for printing and project collaboration, specifically to online project collaboration with on-demand printing, real-time communication, and/or real-time project change.

### Description of the Related Art

Project management relates to initiating, planning, executing, controlling and/or closing the work of a team to achieve goals and/or meet success criteria. Tools have been developed to facilitate project work and project management. While project management is relevant to many fields of endeavor, it has historical roots in construction and engineering. Generally, before 1950, master builders/architects/engineers would manage projects themselves. Around 1950, organizations began using more systematized approaches and developing more advanced project management tools and techniques than simple Gantt charts to complete such projects. Since then, many organizations have developed various standards for project management, including but not limited to ISO 215002012, ISO 31000:2009, GAPPS, PRINCE2, and TSP.

Computing systems have been developed to facilitate project management. As the internet has developed, such tools have become accessible online and computing systems that allow for multiple users to interact with a single project management system have come into being. Such systems generally provide tools for at least one or more of issue tracking, scheduling, resource management, document management, workflow systems, reporting, and/or analysis. Some systems provide limited financial tracking, such as but not limited to invoicing and/or time tracking. Such systems are now used in fields other than construction and engineering, including but not limited to software development, manufacturing, and research and development.

Examples of references related to the present invention are provided below, described in their own words, and the supporting teachings of each reference are incorporated by reference herein:

U.S. Pat. No. 6,581,040 discloses systems for providing enhanced communications for the managing of projects, particularly to project communications involving multiple resource providers. The invention provides for a network accessed business system and database. The system permits parallel public, limited, and proprietary access to database information for the purpose of establishing and managing projects requiring multiple, and potentially competitive, resource providers. The invention specifically provides for the exchange of information required between project owners, project managers, and competitive, bidding resource providers necessary to assemble and manage both materiel and an effective project team.

U.S. Pat. No. 7,089,203 discloses a system and method (“Bid System”) for topologically subdividing and defining the detail scope of work and for inter-linking construction plans and specifications to construction contracts and subcontracts. The Bid System permits fill clear and unambiguous definition of the scope of work under each subcontract, so as to eliminate errors and uncertainty relating to contract performance. The Bid System establishes a series of electronic overlays to the digitized construction plans corresponding to different trades or categories of work, in which each overlay may be divided into a series of optimized topological subdivisions or “boxes” which uniquely identify and locate on the plans a portion of the work to be performed. The system includes linkage of the overlays and boxes to the subcontracts whereby the scope of work to be bid is accurately associated or “mapped” to corresponding regions and overlay category on the architectural drawings or construction plans. This mapping of overlays to plans constitutes a system of almost-orthogonal equations having the property of progressively increasing transparency as the typical size of the subdivisions is reduced. The system and method also permits a bi-directional flow of information from the various entities involved in the bid process so as to enhance the clarity and detail of work description of both the contracts and the plans and specifications, thus permitting more efficient and effective monitoring and management of contract performance. Internet-based embodiments of the Bid System of the invention are described, including a central-server remote host Internet embodiment in which the transmittal of data, including plans, overlays, contracts, bids, comments, edits, changes and the like are via the Internet, the Bid System being operated principally on a central remote host operated by a Bid System Service Provider (BSSP). Distributed host Internet embodiments are also disclosed.

US Patent Application No. 2006/0010005 discloses a system of managing building construction including a set of modules including a land module, a money module, a product module, a worker module, a buyer module, and an integration module configured to integrate information and services from the set of modules. There is a method of managing building construction, including providing a database, populating the database with linked information relating to each of a parcel of land, a lender of money, a supplier of product, a supplier of a worker, and a buyer, and enabling the buyer, through the database, to interface with each of the lender of money, the supplier of product, the supplier of the worker, and a government agency governing the parcel of land.

US Patent Application No. 2010/0185547 discloses an interactive and collaborative, planning, designing and facilitating tool that connects users with organized information and relevant data, providers and facilitators to resolve technical issues in conceptualizing, designing and implementing a custom project.

The inventions heretofore known suffer from a number of disadvantages, including but not limited to: being difficult to use, not being sufficiently collaborative, being slow, not being convenient, failing to reduce travel time and/or in-person meeting requirements for users, not being transparent, failing to reduce errors over other systems, having slow error correction, not providing an easy to understand big picture of the project, having slow approvals within the system, and/or slow changes.

What is needed is a system and/or method that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available printing and/or project collaboration systems and methods. Accordingly, the present invention has been developed to provide a method and/or a system for printing and project collaboration over a network.

There may be a computerized method for printing and project collaboration over a network, that may include one or more of steps of generating a virtual collaborative plan room within a project management system associated with a job and a plurality of user accounts, wherein users associated with the plurality of user accounts may be able to be logged in concurrently; receiving project files over the network via a network interface controller; associating the project files with the job; publishing a subset of the project files to a plurality of contractor user accounts along with a request for a bid and/or receiving and/or storing bids from the plurality of contractor user accounts; locking a file of the project files while being edited by an editing user account from the plurality of user accounts such that only the editing user account(s) can generate edit requests on the locked file, thereby generating a locked file; processing edit requests to the locked file using a processor from the plurality of user accounts in real-time thereby generating edits to project files; automatically recording, in an audit record associated with the job and stored on a data storage device, edits to project files; unlocking the locked file thereby updating the project files; sending, over the network, a print request to a printing system, including one or more of a copy of one or more project files, a printing parameter, and/or a printing price request; receiving a printing price from the printing system and/or associating the printing price with the print request; and/or publishing the printing price to the plurality of users.

It may be that user accounts of the printing system are automatically granted user accounts in the project management system. It may be that the step of unlocking the locked file includes preserving a pre-edited version of the locked file within the job.

There may be one or more steps of displaying, to the plurality of user accounts in real-time, edits made on the locked file; unlocking the locked file for another editing user account such that the editing user account and the another editing user account are able to edit the locked file concurrently; and/or publishing an edit notice relating to a particular edited file to a user account that had previously generated the print request associated with the particular edited file before it had been edited.

There may be a computerized system of printing and project collaboration (collaborative project management system) over a network, that may include one or more of the following: a virtual collaborative plan room; a plurality of user accounts that may be in functional communication with the virtual collaborative plan room and may be able to login concurrently into the virtual collaborative plan room; a data storage device in functional communication with the virtual collaborative plan room and with the plurality of user accounts that may include a plurality of project files associated with a job of the virtual collaborative plan room; a file locker that may be in functional communication with the data storage device and/or the plurality of user accounts and that may lock and/or unlock project files from editing with respect to particular user accounts; a real-time file editor that may be in functional communication with the data storage device and/or the plurality of user accounts that processes edit requests to project files; an edit auditor that may be in functional communication with the real-time file editor and/or the data storage device that automatically records edits to project files; and print job request utility that may be in functional communication with a printing system via a network interface controller, with the plurality of user accounts, and/or with the data storage device such that it can send print requests to the printing system, including one or more of a copy of one or more project files, a printing parameter, and/or a printing price request.

There may be one or more of a bid manager that manages bids from contractor user accounts; and/or a notice publisher that may be in functional communication with the file locker and/or with the data storage device that publishes an edit notice relating to a particular edited file to a user account that had previously generated the print request associated with the particular edited file before it had been edited.

It may be that user accounts of the printing system are automatically granted user accounts in the project management system. It may be that user interfaces of the plurality of user accounts display, to the plurality of user accounts in real-time, edits made on the locked file. It may be that the file locker preserves a pre-edited version of a locked file within the job before unlocking the locked file.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawing(s). It is noted that the drawings of the invention are not to scale. The drawings are mere schematics representations, not intended to portray specific parameters of the invention. Understanding that these drawing(s) depict only typical embodiments of the invention and are not, therefore, to be considered to be limiting its scope, the invention will be described and explained with additional specificity and detail through the use of the accompanying drawing(s), in which:

FIG. 1 is a network diagram of a collaborative project management system in situ, according to one embodiment of the invention;

FIG. 2 is a module diagram of a collaborative project management system, according to one embodiment of the invention;

FIG. 3 is a flowchart showing a computerized method of printing and project collaboration, according to one embodiment of the invention;

FIG. 4 is a prophetic screenshot of a plan room of a collaborative project management system, according to one embodiment of the invention;

FIG. 5 is a prophetic screenshot of a collaborative project management system showing a locked file, according to one embodiment of the invention; and

FIG. 6 is a prophetic screenshot of a dashboard of a plan room of a collaborative project management system, according to one embodiment of the invention.

### DETAILED DESCRIPTION OF THE INVENTION

For the purposes of promoting an understanding of the principles of the invention, reference will now be made to the exemplary embodiments illustrated in the drawing(s), and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to an “embodiment,” an “example” or similar language means that a particular feature, structure, characteristic, or combinations thereof described in connection with the embodiment is included in at least one embodiment of the present invention. Thus, appearances of the phrases an “embodiment,” an “example,” and similar language throughout this specification may, but do not necessarily, all refer to the same embodiment, to different embodiments, or to one or more of the figures. Additionally, reference to the wording “embodiment,” “example” or the like, for two or more features, elements, etc. does not mean that the features are necessarily related, dissimilar, the same, etc.

Each statement of an embodiment, or example, is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The features, functions, and the like described herein are considered to be able to be combined in whole or in part one with another as the claims and/or art may direct, either directly or indirectly, implicitly or explicitly.

As used herein, “comprising,” “including,” “containing,” “is,” “are,” “characterized by,” and grammatical equivalents thereof are inclusive or open-ended terms that do not exclude additional unrecited elements or method steps, “Comprising” is to be interpreted as including the more restrictive terms “consisting of” and “consisting essentially of.”

The various system components and/or modules discussed herein may include one or more of the following: a host server, motherboard, network, chipset or other computing system including a processor for processing digital data; a memory device coupled to a processor for storing digital data; an input digitizer coupled to a processor for inputting digital data; an application program stored in a memory device and accessible by a processor for directing processing of digital data by the processor; a display device coupled to a processor and/or a memory device for displaying information derived from digital data processed by the processor; and a plurality of databases including memory device(s) and/or hardware/software driven logical data storage structure(s).

Various databases/memory devices described herein may include records associated with one or more functions, purposes, intended beneficiaries, benefits and the like of one or more modules as described herein or as one of ordinary skill in the art would recognize as appropriate and/or like data useful in the operation of the present invention.

As those skilled in the art will appreciate, any computers discussed herein may include an operating system, such as but not limited to: Android, iOS, BSD, IBM z/OS, Windows Phone, Windows CE, Palm OS, Windows Vista, NT, 95/98/2000, OS X, OS2; QNX, UNIX; GNU/Linux; Solaris; MacOS; and etc., as well as various conventional support software and drivers typically associated with computers. The computers may be in a home, industrial or business environment with access to a network. In an exemplary embodiment, access is through the Internet through a commercially-available web-browser software package, including but not limited to Internet Explorer, Google Chrome, Firefox, Opera, and Safari.

It should be appreciated that such functional blocks and etc. may be realized by any number of hardware and/or software components configured to perform the specified functions. For example, the present invention may employ various integrated circuit components, e.g., memory elements, processing elements, logic elements, scripts, look-up tables, and the like, which may carry out a variety of functions under the control of one or more microprocessors or other control devices. Similarly, the software elements of the present invention may be implemented with any programming or scripting language such as but not limited to Eiffel, Haskell, C, C++, Java, Python, COBOL, Ruby, assembler, Groovy, PERL, Ada, Visual Basic, SQL Stored Procedures, AJAX, Bean Shell, and extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention may detect or prevent security issues with a client-side scripting language, such as JavaScript, VBScript or the like.

Additionally, many of the functional units and/or modules herein are described as being “in communication” with other functional units, third party devices/systems and/or modules. Being “in communication” refers to any manner and/or way in which functional units and/or modules, such as, but not limited to, computers, networks, mobile devices, program blocks, chips, scripts, drivers, instruction sets, databases and other types of hardware and/or software, may be in communication with each other. Some non-limiting examples include communicating, sending, and/or receiving data and metadata via: a wired network, a wireless network, shared access databases, circuitry, phone lines, internet backbones, transponders, network cards, busses, satellite signals, electric signals, electrical and magnetic fields and/or pulses, and/or so forth.

As used herein, “processor” means a computerized component that provides operational instructions and commands to the modules and components of the system and processes returned signals. The processing system is in communication with the modules and components of the system (and/or other modules described herein) and provides managerial instructions and commands thereto. The source of such instructions/commands may be from one or more other modules described herein and/or through interactions between one or more other modules described herein. The processing system sets parameters and settings for each module and component of the system. Non-limiting examples of a processing system may be a control module described in U.S. Pat. No. 5,430,836, issued to Wolf et al; or a control module described in U.S. Pat. No. 6,243,635, issued to Swan et al. which are incorporated for their supporting teachings herein. A control module may include but is not limited to a processor, a state machine, a script, a decision tree, and the like.

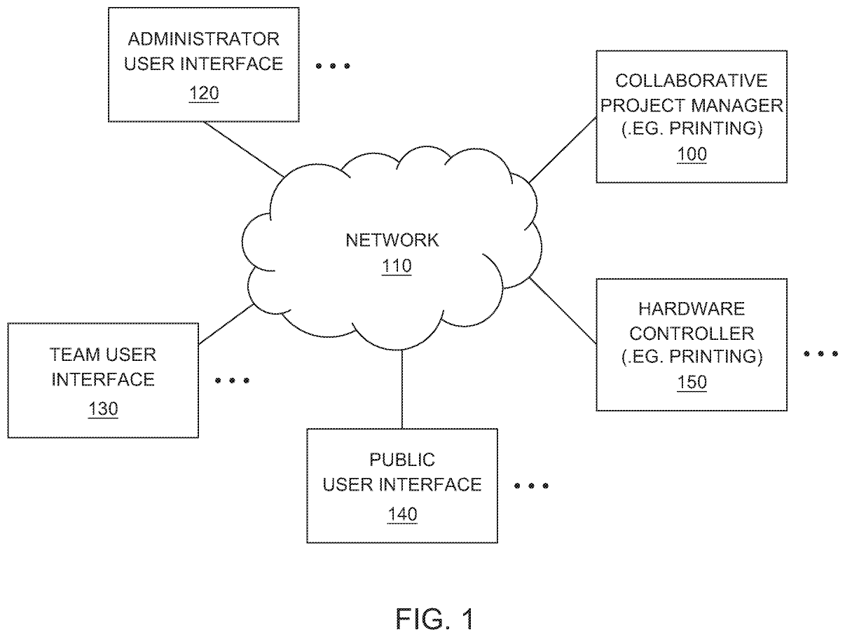

FIG. 1 illustrates a collaborative project management system (CPMS) 100 in the context of a network 110 and associated hardware/software, according to one embodiment of the invention. The illustrated network 110 couples the CPMS to a plurality of illustrated user interface devices, including those for administrators 120, team members 130, and public users 140. The network 110 also couples the CPMS to one or more hardware controllers 150 such as but not limited to printers, 3D printers, cutting jigs, embroidery machines, and the like and combinations thereof.

The illustrated CPMS allows users to create and manage projects in association with others. The system allows users to create jobs within the projects, assign access rights to other users and/or classes of users (including public users who might not have verified accounts), request and submit bids, manage tasks, track changes to plans/documents/media files, provide audit trail information associated with such changes, provide real-time communication and collaboration on projects, including real-time change requests and approvals within a virtual plan room, upload documents and other media files, and cause printing of documents and related media files to occur, on-demand and in real-time.

The illustrated CPMS provides users with file storage, audit trail recording, communication tools (real-time and otherwise), project tracking, project organization, user access definitions, and bid management functionality. The project management and collaboration module may include one or more chatroom-style applications, such as but not limited to: Flock by Riva FZC, iMessage, Skype, Twitter, Facebook Messenger, Google Hangouts and the like and combinations thereof. The CPMS may include one or more cloud file storage/upload applications, such as but not limited to Egnyte, DropBox, Azure Cloud (by Microsoft), and Google Drive. The CPMS module may include project tracking, project organization, and/or audit trail functionality, such as but not limited to that provided by Project Insight by Metafuse Incorporated of Irvine Calif. The CPMS may include authorization and access management software such as but not limited to janrain by Janrain, Inc. of Portland Oreg.

The CPMS may operate on one or more servers. Non-limiting examples of servers include: a HP MediaSmart Server EX495, manufactured by Hewlett-Packard Company, 3000 Hanover Street, Palo Alto, Calif., 94304, USA; an Intel Server System SR2500ALBKPR, manufactured by Intel Corporation, 2200 Mission College Blvd, Santa Clara, Calif., 95054, USA.

The CPMS may include a contact management utility, such as but not limited to CRM software, databases, or spreadsheets. One non-limiting example of a contact management utility may be a Microsoft Dynamic CRM, manufactured by Microsoft Corp., One Microsoft Way, Redmond, Wash., 98052.

The CPMS may also provide a virtual plan room where users can simultaneously meet regarding a particular project/job. There is a graphical user interface for the project management and collaboration module wherein each project has a custom plan room associated therewith that is accessible, to the degree authorized, by those with the appropriate access rights defined in association with their accounts. The plan room may include links to documents and/or media files, links to activate features present in the CPMS and other modules herein, and/or a central graphical user interface where participants in the project/job may interact with each other to work on the project (e.g. holding meetings regarded proposed or needed changes to plans).

The illustrated network includes any electronic communications means which incorporates both hardware and software components of such. Communication among the parties in accordance with the present invention may be accomplished through any suitable communication channels, such as, for example, a telephone network, an extranet, an intranet, Internet, point of interaction device (point of sale device, personal digital assistant, cellular phone, kiosk, etc.), online communications, off-line communications, wireless communications, transponder communications, local area network (LAN), wide area network (WAN), networked or linked devices and/or the like. Moreover, although the invention may be implemented with TCP/IP communications protocols, the invention may also be implemented using other protocols, including but not limited to IPX, Appletalk, IP-6, NetBIOS, OSI or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997), the contents of which are hereby incorporated by reference.

The illustrated network and the functional communication between modules of the system provides communication capabilities, such as wireless communication, to the modules and components of the system and the components and other modules described herein. There may be one or more hardware devices such as a network card, system buts, or wireless communication module that may communicate with a computerized network. The communication system may provide communication between a wireless device, such as a mobile phone, and a computerized network and/or to facilitate communication between a mobile device and other modules described herein. The communication system may have a component thereof that is resident on a user's mobile device. Non-limiting examples of a wireless communication module may be but not limited to: a communication module described in U.S. Pat. No. 5,307,463, issued to Hyatt et al.; or a communication module described in U.S. Pat. No. 6,133,886, issued to Fariello et al., which are incorporated for their supported herein.

The illustrated user interfaces (120, 130, and 140) (generally Graphical User Interfaces (GUI)) enable users to interact with the functions of an application through graphical icons and other visual indicators. The GUI receives input from the user and displays output to the user and as such may submit instructions from the user to the system and may receive feedback from the system with respect to its operation. The GUI exists in the context of a user device used by a user. The user device generally includes a processor or processing circuitry, a random access memory (RAM), data storage devices (e.g., hard, floppy, flash memory, ROM, and/or CD-ROM disk, drives, etc.), data communications devices (e.g., modems, network interfaces, transceivers, cellular network interfaces, etc.), display devices (e.g., CRT, LCD display, etc.), and input devices (e.g., touch screen, buttons, mouse pointing device, keyboard, CD-ROM drive, etc.). Such may include an interface module that may be a HTML player, client server application, Java script application. A non-limiting example of an interface module is FlowPlayer 3.1, manufactured by FlowPlayer LTD, Hannuntie 8 D, ESPOO 02360, Helsinki, Finland. It is envisioned that attached to the user device may be other devices, such as read only memory (ROM), a video card, bus interface, printers, etc. Those skilled in the art will recognize that any combination of the above components, or any number of different components, peripherals, and other devices, may be used with the user device. The user device operates under the control of an operating system (OS). The operating system is generally booted into the memory of the user device for execution when the user device is powered-on, reset, or otherwise activated. In turn, the operating system then controls the execution of one or more applications. An application, including the OS, can include a GUI, which facilitates interaction of the user with the application. The GUI includes instructions which, when read and executed by the user device, cause the (GUI to perform the steps necessary to configure and/or operate the GUI of the application.

The illustrated hardware controllers 150 are generally chips, expansion cards, or stand-alone devices that interface with a peripheral device (e.g. memory, hard drive, printer). This may be a link between two parts of a computer (for example a memory controller that manages access to memory for the computer) or a controller on an external device that manages the operation of (and connection with) that device. In desktop computers the controller may be a plug in board, a single integrated circuit on the motherboard, or an external device. In mainframes the controller is usually either a separate device attached to a channel or integrated into the peripheral.

In one non-limiting embodiment, there is a collaborative plan room where the engineering architectural and construction fields can use it to access electronic files, and/or make real-time changes with others in the field to speed up the process of getting their plans updated so they have a real-time plan no matter where the individuals are located. There may be a printing feature that allows printing of the real-time plans.

In another non-limiting embodiment, there is a collaborative enterprise solution that may be used for the architecture, engineering, and/or construction industries where they will be able to share and make changes real-time. There may be file sharing, web sharing, and/or real-time communications. Outside vendors may be able to view such as well through a portal. There may be multiple revenue streams for this which may include monthly service fees and/or printing fees. There may be multiple tiers for each seat. The system may be scaled to be provided to and for repro-graphic companies. A user may be able to create an account for an entire team within the system. The system may allow one to be selective as to who can view documents. It may allow a team to make real-time edits. It may have a self-backup feature that allows one to revert back to previous versions. The system may be seamless and/or may allow each team member to have custom access and/or make real-time changes to the project. The system may allow one to bring in outside resources by generating a user account for such and giving that account access to a project. There may be public accounts that have a public level of access to projects.

In still yet another embodiment, there is a real-time project management solution that is duplicate-able across different printing companies, whose clients then get accounts.

In yet still another further embodiment, there is a website that combines multiple traditional sites into one. It combines a plan room, a collaborative area, and an area for customized images (size and materials). Within each site or area, there may be multiple sub-sites, which may depend on membership level(s) of the various users, for end users (front and) and administrators (back end) alike. Within these areas one can upload files for both bidding and printing on projects, send and receive large files quickly and or editing files to make real-time changes (collaborative) with multiple users getting real-time updates on files, instantly. There may be features from one or more of Bluebeam.com (e.g. collaborative functions), reproconnect.com (plan room functions), dropbox.com (large file FTP functions), bidmail.com (plan room functions), vistaprnnt.com (customized image functions) but all on one site.

It may be that all the different sub-sites talk and update files together so a seamless interface with each user is communicated at each level and stage of the project.

In operation, a super-user having an administrator account may create a member account. That member account may create a project, thus becoming an administrator of the project. The administrator may authorize a plurality of users to have access to the project and its associated plan room and may set limited public access to the same. The administrator may communicate in real-time with other users through the plan room (e.g. chatroom functionality, voice-chat, video-chat) and may make real-time changes to the various documents, plans, settings, job lists, job details, and the like during such a discussion. Other users may mark such changes with their approval/authorization in real-time through the plan room interface. The system keeps an audit trail of all such changes, commentary, authorizations, and the like. The user's may, through the plan room interface, invite other users to authorize/approve or otherwise comment on specific changes/files/documents and the system may automatically send notification(s) out to such users requesting their input.

Advantageously, the system provides a nexus of communication in regards to a project and allows for real-time discussion about the same, while carefully tracking any and all changes to the project, including who made such changes, who witnessed the changes and any commentary on such changes. The system beneficially reduces the need for in-person meetings in regards to the associated projects and allows for rapid project development, management, and quick printing services for all involved.

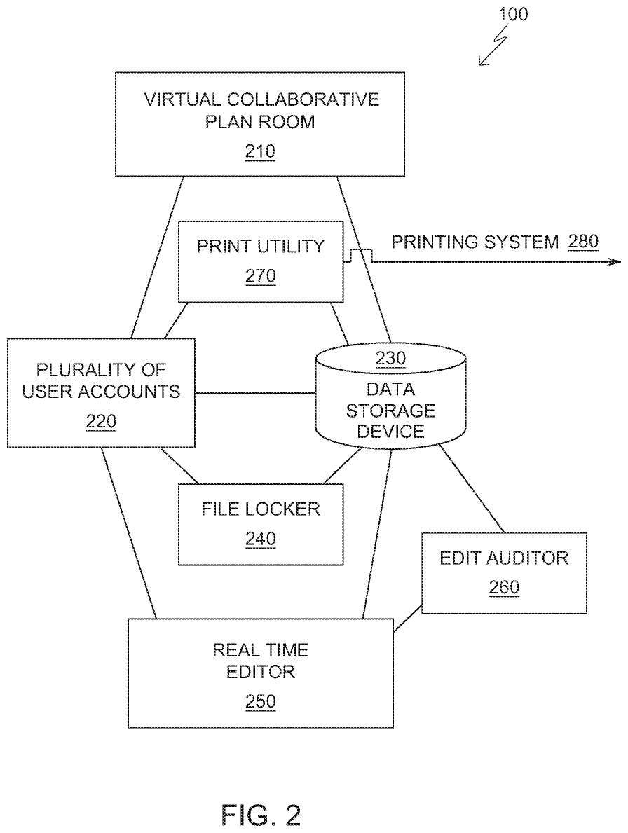

FIG. 2 is a module diagram of a collaborative project management system 100, according to one embodiment of the invention. There is shown a virtual collaborative plan room 210 in functional communication with each of a plurality of user accounts 220 and a data storage device 230. The plurality of user accounts 220 and the data storage device 230 are each in functional communication with a file locker 240, a real-time editor 250, and a print utility 270. The real-time editor 250 and the data storage device 230 are each in functional communication with an edit auditor 260. The print utility 270 is in functional communication with a printing system 280, which may be a third party service.

The illustrated virtual collaborative plan room puts all the functionality of multiple sites into one location, specifically: a collaborative site, a plan room site, and an upload site. Such sites may be coded (e.g. customized Wordpress themes) to provide one or more aspects of functionality as described herein. Such may include a full and complete audit trail for anything within a project. Such may allow team members to share important documents and files, may provide real-time updates and tracking for each project, and allow for administrators to select what detailed information to provide to team members throughout the design, construction, and/or implementation of each project, allow one or more of each account owner/manager, sub-contractor, and/or each team member to search/view/bid jobs/projects, post jobs/projects, filter jobs/projects, view document/file/plan histories and/or audit trails, view bidders and/or bidding history, approve/accept bids, share plans/documents/media files and comment/reply on the same from remote user interface devices (e.g. smartphones, tablets, personal computers), customize, brand/skin/decorate graphical user interfaces and plan rooms, share/interact via project communications tools, set alerts and tasks and assign the same to one or more users, and/or order printed documents. The virtual plan room includes project tracking, project organization, and/or audit trail functionality, such as but not limited to that provided by Project Insight by Metafuse Incorporated of Irvine Calif. The PC&C module may include authorization and access management software such as but not limited to janrain by Janrain, Inc. of Portland Oreg.

The illustrated plurality of accounts provide channeled access for users to the system. Such may include an account manager. The account manager provides management and administration capabilities to the users of the system via a plurality of accounts associated with each user. The account manager is configured to manage a plurality of accounts and the characteristics and parameters associated therewith. The account manager is configured to store personal and other data relating to the user and the associated account. In addition, the user account module is configured to store and set parameters, characteristics, preferences, settings, etc. Non-limiting examples of an account manager may be an account management module as described in U.S. Patent Publication No.: 2003/0014509; or a management module as described in U.S. Pat. No. 8,265,650, which are incorporated for their supporting teachings herein.

The illustrated data storage device data storage system collects and store data for each of the modules of the system, as appropriate to the functions thereof. The data storage device/system is in communication with the various modules and components of the system over a computerized network and stores data transferred there through. The data storage system stores data transferred through each of the modules of the system, thereby updating the system with up to date data. The data storage system securely stores user data along with data transferred through the system. Data storage systems may include databases and/or data files. There may be one or more hardware memory storage devices, which may be, but are not limited to, hard drives, flash memory, optical discs, RAM, ROM, and/or tapes. A non-limiting example of a data base is Filemaker Pro 11, manufactured by Filemaker Inc., 5261 Patrick Henry Dr., Santa Clara, Calif., 95054. Non-limiting examples of a data storage module may include: a HP Storage Works P2000 G3 Modular Smart Array System, manufactured by Hewlett-Packard Company, 3000 Hanover Street, Palo Alto, Calif., 94304, USA; or a Sony Pocket Bit USB Flash Drive, manufactured by Sony Corporation of America, 550 Madison Avenue, New York, N.Y., 10022.

The illustrated file locker 240 locks and unlocks access to files. Such may include account level granularity, such that the file is only locked unlocked for particular user accounts. The locker may simply flag/unflag a file as locked within the metadata for that file, so long as the file editor (e.g. real-time editor 250) recognizes the flag and prevents a user from editing the file when it is locked to that user. As a non-limiting example, the file locker may enter a user ID into a Locked record of the metadata of the file and that may signify to the real-time editor 250 that the file is locked for all users except that user. Where the file locker appends a second user ID to that same record, editing may be allowed for those two users, and so forth. To unlock the file, the file locker may delete the user ID(s) from that record, returning it to a null state, which the real-time editor treats as the file being unlocked. The file locker may be automatically activated by the real-time editor when a user begins to edit a particular file and may automatically lock that file from edits from users other than the one that is presently editing the file.

The illustrated real-time editor 250 allows for file editing. Non-limiting examples of file editors include: Word, Excel, PowerPoint, and Sharepoint by Microsoft Corporation of Redmond, Wash.; Acrobat DC by Adobe Systems, Inc. of San Jose, Calif.; and AutoCAD, Inventor, Fusion 360, Architecture Toolset, by Autodesk of San Francisco, Calif. The real-time editor 250 may

The illustrated edit auditor 260 may be integrated into the real-time editor and may record changes as they occur (e.g. may comprise the undo memory found in many file editors) and/or it may comprise a file comparison utility that compares an original file to an edited file and may mark the changes on a markup file (similar to compare files in Word). The edit auditor may record which user account made which changes. The editor account may require users to annotate changes so that the reasoning for the change is documented within the system. The edit auditor may store an original, unedited version of each file.

The illustrated print utility 270 allows for users to generate print requests and is functionally coupled to the printing system such that print requests may be transmitted thereto and printing bids may be returned therefrom and displayed to the appropriate user(s). The print utility may also include a print job calculator that estimates print jobs for users based on the number of copies to be printed and characteristics of the print job (e.g. color or b/w, size of paper, type of paper, singe/double sided, resolution requirements) in association with estimated printing costs.

The illustrated printing system 280 includes one or more printers with one or more printing controllers, along with communication system that may couple to automated print bid generators that calculate a price for a particular print job based on a script using the number of copies to be printed and characteristics of the print job (e.g. color or b/w, size of paper, type of paper, singe/double sided, resolution requirements). Most printers other than line printers accept control characters or unique character sequences to control various printer functions. These may range from shifting from lower to upper case or from black to red ribbon on typewriter printers to switching fonts and changing character sizes and colors on raster printers. Early printer controls were not standardized, with each manufacturer's equipment having its own set. The IBM Personal Printer Data Stream (PPDS) became a commonly used command set for dot-matrix printers.

Many printers accept page description languages (PDLs). Laser printers with greater processing power frequently offer support for variants of Hewlett-Packard's Printer Command Language (PCL), PostScript or XML Paper Specification. Most inkjet devices support manufacturer proprietary PDLs such as ESC/P. The diversity in mobile platforms have led to various standardization efforts around device PDLs such as the Printer Working Group (PWG's). Generally, printers, when purchased, come with controllers and the associated software to operate the controllers.

In one non-limiting embodiment of the invention, there may be a computerized system of printing and project collaboration over a network, that may include one or more of the following: a virtual collaborative plan room; a plurality of user accounts in functional communication with the virtual collaborative plan room, able to login concurrently into the virtual collaborative plan room; a data storage device in functional communication with the virtual collaborative plan room and with the plurality of user accounts including a plurality of project files associated with a job of the virtual collaborative plan room; a file locker in functional communication with the data storage device and the plurality of user accounts that locks and unlocks project files from editing with respect to particular user accounts; a real-time file editor in functional communication with the data storage device and the plurality of user accounts that processes edit requests to project files; an edit auditor in functional communication with the real-time file editor and the data storage device that automatically records edits to project files; and print job request utility in functional communication with a printing system via a network interface controller, with the plurality of user accounts, and with the data storage device such that it can send print requests to the printing system, including: a copy of one or more project files, a printing parameter, and a printing price request.

There may be one or more of a bid manager that manages bids from contractor user accounts; and a notice publisher in functional communication with the file locker and with the data storage device that publishes an edit notice relating to a particular edited file to a user account that had previously generated the print request associated with the particular edited file before it had been edited. When a bid is selected, the system may automatically close out a particular job to other user accounts and may automatically upgrade access to the user account of the winning bidder(s), thereby granting them more access/control/editing functionality than when their account was just one of many bidders. The job may then automatically change in status from bidding to awarded (or the like) and that may be updated within a master planning tool for the larger project of which the job is a part.

In one non-limiting embodiment, after a bid has been awarded to a contractor, the owner, architect, contractor and sub-contractors would still have access to the files in their plan room as a private job, to collaborate with each other on aspects of the buildout of the project, e.g. using the collaborative plan room tools for clarification, and RFI's (request for information) amongst the invited companies, continuing to update files and/or creating automatic audit trails within the project to its completion.

It may be that user accounts of the printing system are automatically granted user accounts in the project management system. It may be that user interfaces of the plurality of user accounts display, to the plurality of user accounts in real-time, edits made on the locked file. It may be that the file locker preserves a pre-edited version of a locked file within the job before unlocking the locked file.

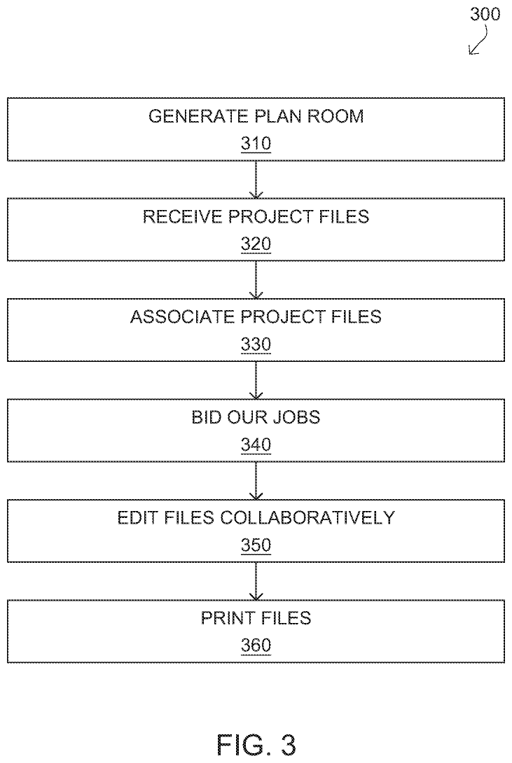

FIG. 3 is a flowchart showing a computerized method of printing and project collaboration 300, according to one embodiment of the invention. There is shown the steps of generating a plan room 310, followed by receiving project files 320, followed by associating project files 330, followed by bidding out jobs 340, followed by editing files collaboratively 350, followed by printing files 360. Such may be accomplished over a computerized network.

The step of generating a plan room 310 may include generating a virtual collaborative plan room within a project management system associated with a job and a plurality of user accounts. It may be that users associated with the plurality of user accounts are able to be logged in concurrently. The system may store metadata associated with a plan room, including but not limited to: owner, user IDs allowed to join, job/project name, job/project description, job/project location, bid date, job type, contact person/company, list of associated files, job/project dates/milestones, creation date, notes, display characteristics (e.g. color scheme, background image(s)), allowed/enabled features (e.g. if there are extra features that the primary account for the pan room has paid for or enabled/disabled on setup), and the like and combinations thereof. When an instance of the plan room is loaded for active use, that metadata may be used by the system to populate display areas of the plan room and/or generate/manage the plan room.

The step if receiving project files 320 may include wherein such are received over the network via a network interface controller. Such files may be uploaded from user interface devices of one or more users. Once uploaded, they may be renamed within the system. Particular users may be notified of the upload and that notification may automatically include an invite to the plan room.

The step of associating the project files 330 may include wherein such are associated with one or more jobs. The system may append an associative data record/field to the file and/or the job that points to the associated file and/or job. Such may then automatically include the file in a list of files for a job. This advantageously allows for a single file to be utilized for multiple jobs without having to be reuploaded each time.

The step of bidding out job(s) 340 may include publishing a subset of the project files to a plurality of contractor user accounts along with a request for a bid and receiving and storing bids from the plurality of contractor user accounts. The system may include a bidding wizard that allows a user (generally the project/job owner) to enter a job description/requirements, associate files with that job, identify user accounts to which the job is to be sent for bidding (e.g. could be a class of user accounts, e.g. all electrical engineering user accounts for an electrical engineering job), and provide contact information for reply bids to be sent. The system then automatically packages the same and sends it to the intended recipients over the network. Such may also provide a wizard to the recipients for generating a bid response, including allowing for upload and association of files, fields to enter bid amounts and other information descriptive of their bid, and contact information. The system may notify the job/project owner of received bids and provide them in a sortable list where selection of a particular bid response allows for more information about the bid response to be seen. There may be fields for annotating the bid responses to help in selecting candidate bids. There may be options to request additional information from the bidders.

The step of editing files collaboratively 350 may include locking a file of the project files while being edited by an editing user account from the plurality of user accounts such that only the editing user account can generate edit requests on the locked file, thereby generating a locked file. Such may also include processing edit requests to the locked file using a processor from the plurality of user accounts in real-time thereby generating edits to project files. Such may also include automatically recording, in an audit record associated with the job and stored on a data storage device, edits to project files; unlocking the locked file thereby updating the project files. It may be that the step of unlocking the locked file includes preserving a pre-edited version of the locked file within the job. There may also be steps of displaying, to the plurality of user accounts in real-time, edits made on the locked file; and unlocking the locked file for another editing user account such that the editing user account and the another editing user account are able to edit the locked file concurrently

The step of printing file(s) 360 may include sending, over the network, a print request to a printing system, including: a copy of one or more project files, a printing parameter, and/or a printing price request. Such may also include receiving a printing price from the printing system and associating the printing price with the print request. Such may also include publishing the printing price to the plurality of users. It may be that user accounts of the printing system are automatically granted user accounts in the project management system. It may be that the system publishes an edit notice relating to a particular edited file to a user account that had previously generated the print request associated with the particular edited file before it had been edited.

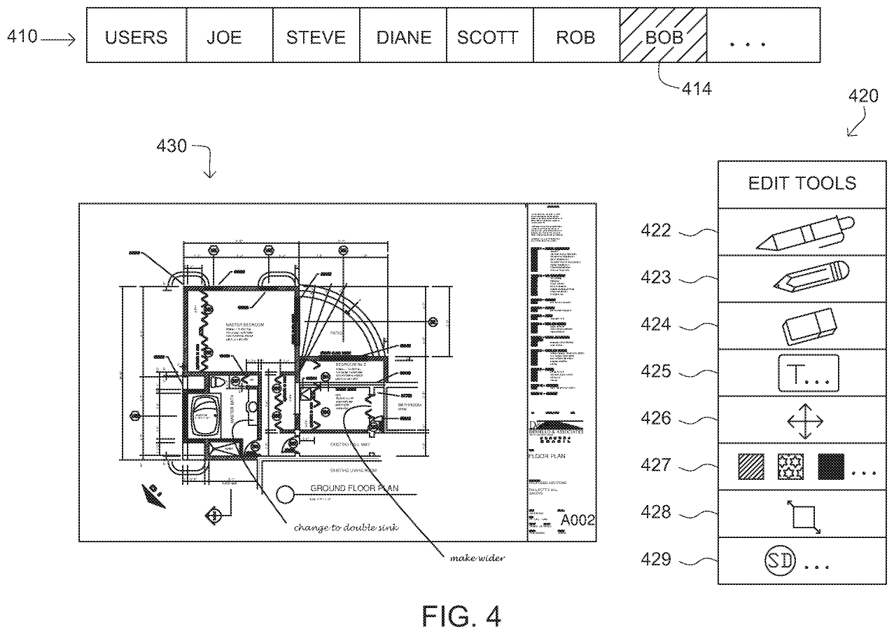

FIG. 4 is a prophetic screenshot of a plan room of a collaborative project management system, according to one embodiment of the invention. There is shown a plan room user interface showing a plurality of users simultaneously logged in (the illustrated Joe, Steve, Diane, Scott, Rob, and Bob) 410 with Joe identified as the job owner (listed first) and Bob identified as the active editor 414 via highlighting of Bob's user name on the interface. The interface includes edit tools 420 along with a floor plan 430 displayed on the main portion of the screen with written edits disposed thereon generated by Bob via edit tools.

The illustrated edit tools 420 include a virtual pen 422, virtual pencil 423, virtual eraser 424, text box 425, move object tool 426, color selector 427, size change tool 428, and icon generator 429. Accordingly, an editing user account has access to generate edits to a graphical file while other users are watching in real-time. The various users may be connected by audio/video/text, such as but not limited to being on a conference call and/or video chat and/or being connected via a chat utility. Such may be accomplished via VOIP, video conferencing, chat utilities and the like, which may be incorporated directly into the system or may be operated independently therefrom.

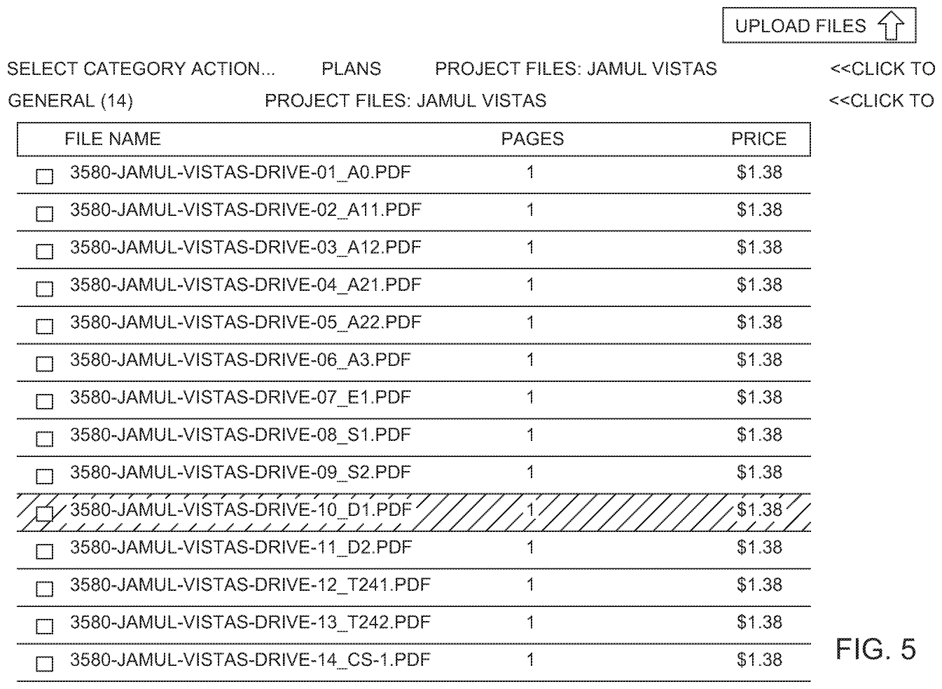

FIG. 5 is a prophetic screenshot of a collaborative project management system showing a locked file, according to one embodiment of the invention. There is shown a file management system including a plurality of files associated with the project “JAMUL VISTAS.” The file named 3580-JAMUL-VISTAS-DRIVE-10_D1.PDF is marked to indicate that the file is locked to the user viewing the list of files. The illustrated file manager also includes a button to activate the upload utility and a selection box adjacent each file to allow for actions to be taken on a file-by-file basis, including requesting print jobs. Estimated/or actual printing fees are shown on the file manager, which fees may have been automatically obtained through a printing system in functional communication with the CPMS.

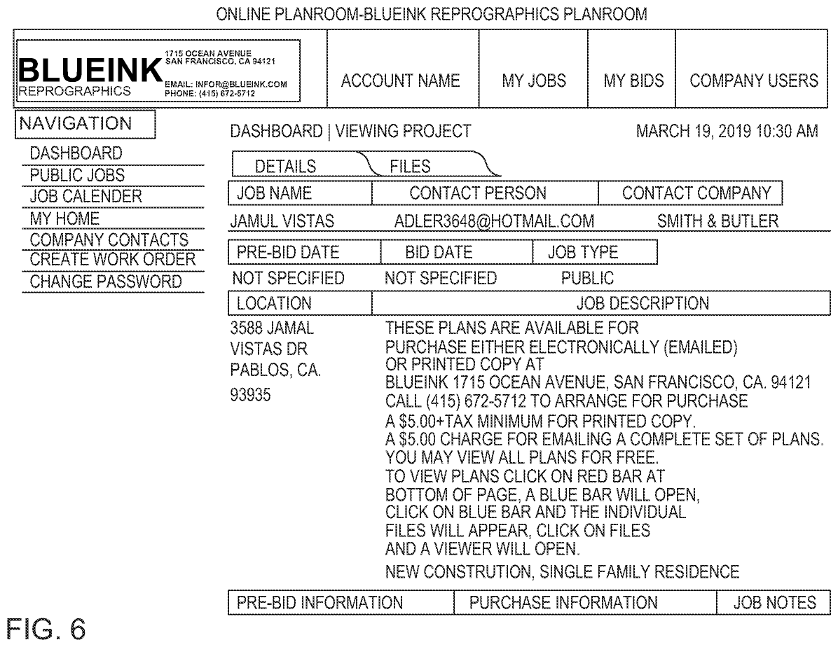

FIG. 6 is a prophetic screenshot of a dashboard of a plan room of a collaborative project management system, according to one embodiment of the invention. There is shown a dashboard of a project (JAMUL VISTAS), including information related to that particular job. There are also selectable navigation options to allow for managing public jobs, viewing/editing a job calendar, accessing the users settings (MY HOME), managing company contracts, creating work orders, managing passwords, viewing all jobs/bids associated with the user (MY JOBS and MY BIDS), and managing the users within the company associated with the user account shown.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claims rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims. Further, it is contemplated that an embodiment may be limited to consist of or to consist essentially of one or more of the features, functions, structures, methods described herein.

What is claimed is:

1. A computerized method for printing and project collaboration over a network, comprising the steps of:
a. generating a virtual collaborative plan room within a project management system associated with a job and a plurality of user accounts, wherein users associated with the plurality of user accounts are able to be logged in concurrently;
b. receiving project files over the network via a network interface controller;
c. associating the project files with the job;
d. locking a file of the project files while being edited by an editing user account from the plurality of user accounts such that only the editing user account can generate edit requests on the locked file, thereby generating a locked file;
e. processing edit requests to the locked file using a processor from the plurality of user accounts in real-time thereby generating edits to project files;
f. automatically recording, in an audit record associated with the job and stored on a data storage device, edits to project files;
g. unlocking the locked file thereby updating the project files;
h. sending, over the network, a print request to a printing system, including:
i. a copy of one or more project files;
ii. a printing parameter; and
iii. a printing price request;
i. receiving a printing price from the printing system and associating the printing price with the print request; and
j. publishing the printing price to the plurality of users.

2. The method of claim 1, wherein user accounts of the printing system are automatically granted user accounts in the project management system.

3. The method of claim 1, further comprising serving a project file download to a user account of the plurality of user accounts.

4. The method of claim 1, further comprising displaying, to the plurality of user accounts in real-time, edits made on the locked file.

5. The method of claim 1, further comprising publishing a subset of the project files to a plurality of contractor user accounts along with a request for a bid and receiving and storing bids from the plurality of contractor user accounts.

6. The method of claim 1, further comprising unlocking the locked file for another editing user account such that the editing user account and the another editing user account are able to edit the locked file concurrently.

7. The method of claim 1, wherein the step of unlocking the locked file includes preserving a pre-edited version of the locked file within the job.

8. The method of claim 1, further comprising publishing an edit notice relating to a particular edited file to a user account that had previously generated the print request associated with the particular edited file before it had been edited.

9. A computerized method for printing and project collaboration over a network, comprising the steps of:
a. generating a virtual collaborative plan room within a project management system associated with a job and a plurality of user accounts, wherein users associated with the plurality of user accounts are able to be logged in concurrently;
b. receiving project files over the network via a network interface controller;
c. associating the project files with the job;
d. publishing a subset of the project files to a plurality of contractor user accounts along with a request for a bid and receiving and storing bids from the plurality of contractor user accounts;
e. locking a file of the project files while being edited by an editing user account from the plurality of user accounts such that only the editing user account can generate edit requests on the locked file, thereby generating a locked file;
f. processing edit requests to the locked file using a processor from the plurality of user accounts in real-time thereby generating edits to project files;
g. automatically recording, in an audit record associated with the job and stored on a data storage device, edits to project files;
h. unlocking the locked ile thereby updating the project files;
i. sending, over the network, a print request to a printing system, including:
i. a copy of one or more project files;
ii. a printing parameter; and
iii. a printing price request;
j. receiving a printing price from the printing system and associating the printing price with the print request; and
k. publishing the printing price to the plurality of users.

10. The method of claim 9, wherein user accounts of the printing system are automatically granted user accounts in the project management system.

11. The method of claim 10, further comprising displaying, to the plurality of user accounts in real-time, edits made on the locked file.

12. The method of claim 11, wherein the step of unlocking the locked file includes preserving a pre-edited version of the locked file within the job.

13. The method of claim 12, further comprising unlocking the locked file for another editing user account such that the editing user account and the another editing user account are able to edit the locked file concurrently.

14. The method of claim 13, further comprising publishing an edit notice relating to a particular edited file to a user account that had previously generated the print request associated with the particular edited file before it had been edited.

15. A computerized system of printing and project collaboration over a network, comprising:
a. a virtual collaborative plan room;
b. a plurality of user accounts in functional communication with the virtual collaborative plan room, able to login concurrently into the virtual collaborative plan room;
c. a data storage device in functional communication with the virtual collaborative plan room and with the plurality of user accounts including a plurality of project files associated with a job of the virtual collaborative plan room;
d. a file locker in functional communication with the data storage device and the plurality of user accounts that locks and unlocks project files from editing with respect to particular user accounts;
e. a real-time file editor in functional communication with the data storage device and the plurality of user accounts that processes edit requests to project files;
f. an edit auditor in functional communication with the real-time file editor and the data storage device that automatically records edits to project files; and
g. print job request utility in functional communication with a printing system via a network interface controller, with the plurality of user accounts, and with the data storage device such that it can send print requests to the printing system, including:
i. a copy of one or more project files;
ii. a printing parameter; and
ii. a printing price request.

16. The system of claim 15, further comprising a bid manager that manages bids from contractor user accounts.

17. The system of claim 15, wherein user accounts of the printing system are automatically granted user accounts in the project management system.

18. The method of claim 15, wherein user interfaces of the plurality of user accounts display, to the plurality of user accounts in real-time, edits made on the locked file.

19. The method of claim 15, wherein the file locker preserves a pre-edited version of a locked file within the job before unlocking the locked file.

20. The method of claim 15, further comprising a notice publisher in functional communication with the file locker and with the data storage device that publishes an edit notice relating to a particular edited file to a user account that had previously generated the print request associated with the particular edited file before it had been edited.
